(19) United States
(12) Patent Application Publication
(10) Pub. No.: US 2025/0340251 A1
(43) Pub. Date: Nov. 6, 2025

(54) Clamp Mechanism for a Utility Rack

(71) Applicant: Kuat Innovations LLC, Springfield, MO (US)

(72) Inventor: Luke Kuschmeader, Springfield, MO (US)

(73) Assignee: Kuat Innovations LLC, Springfield, MO (US)

(21) Appl. No.: 18/652,408

(22) Filed: May 1, 2024

(51) Int. Cl. B62D 33/02

(52) U.S. Cl. CPC B62D 33/0207

(57) ABSTRACT

Clamp devices for a utility rack for a truck bed have upper and lower portions to attach to the rack and the truck bed, respectively. The upper and lower portions of the clamp may be disconnected from each other to remove the utility rack from the truck bed, while leaving the upper portion attached to the utility rack and the lower portion attached to the truck bed. Some embodiments of the upper portion have cavities for receiving part of the lower portion to align the upper and lower portions together. A bolt may be provided to pull the upper and lower portions of the clamp device towards each other, thus securing the utility rack to the truck bed.

### CROSS-REFERENCE TO RELATED APPLICATIONS

None.

### BACKGROUND

### Field of the Invention

This disclosure is in the field of utility racks for use with trucks and utility vehicles. More specifically, this disclosure is in the field of utility racks for attachment to the cargo bed of a truck, and in the field of clamps for attaching utility racks to trucks and utility vehicles.

### SUMMARY OF THE INVENTION

In various embodiments, a clamp device is described for removably attaching a utility rack to a sidewall of a truck bed, and may comprise an upper clamp assembly consisting of an upper clamp body, at least one mounting bolt, at least one mounting nut, and a clamping bolt, wherein the at least one mounting bolt extends through a mounting aperture in the upper body and is threaded into the at least one mounting nut; and a lower clamp assembly comprising a lower clamp body, at least one mounting bolt, at least one mounting nut, wherein the at least one mounting bolt extends through a mounting aperture in the lower body and is threaded into the at least one mounting nut; wherein the clamping bolt extends through an aperture in the upper clamp body and is threaded into a threaded aperture in the lower clamp body for adjusting the distance between the upper clamp body and the lower clamp body; and wherein the upper clamp assembly is configured to remain attached to the utility rack when the clamping bolt is unthreaded from the lower clamp body.

In some embodiments, the inventive device may comprise a cargo rack for attachment to a bed of a truck, the cargo rack comprising a first side rail for attachment to a first sidewall of a bed of a truck, a second side rail for attachment to a second sidewall of a bed of a truck, the second sidewall being laterally opposed to the first sidewall, a first and second clamp device attached to the first side rail, a third and fourth clamp device attached to the second side rail, wherein each of the clamp devices comprise an upper clamp assembly comprising an upper clamp body, at least one mounting bolt, and at least one mounting nut, wherein the at least one mounting bolt extends through a mounting aperture in the upper body and is threaded into the at least one mounting nut; a lower clamp assembly comprising a lower clamp body, at least one mounting bolt, at least one mounting nut, wherein the at least one mounting bolt extends through a mounting aperture in the lower body and is threaded into the at least one mounting nut; and a clamping bolt; wherein the clamping bolt extends through an aperture in the upper clamp body and is threaded into a threaded aperture in the lower clamp body; and wherein the upper clamp assembly remains secured to the utility rack by the at least one mounting bolt when the clamping bolt is unthreaded from the lower clamp body; and wherein the lower clamp assembly remains secured to the sidewall of a truck bed by the at least one mounting bolt when the clamping bolt is unthreaded from the lower clamp body.

### BRIEF DESCRIPTION OF THE DRAWINGS

FIG. 1A is a front perspective view of a utility rack positioned on the bed of a truck.

FIG. 1B is a front perspective view of a utility rack with four attached clamps.

FIG. 2A is perspective view of a first embodiment of an inventive clamp.

FIG. 2B is a side view of the first embodiment of the inventive clamp.

FIG. 2C is a front view of the first embodiment of the inventive clamp.

FIG. 2D is a back view of the first embodiment of the inventive clamp.

FIG. 2E is a rear perspective view of the first embodiment of the inventive clamp.

FIG. 2F is a front perspective view of a lower portion of the first embodiment of the inventive clamp.

FIG. 2G is a rear perspective view of a lower portion of the first embodiment of the inventive clamp.

FIG. 2H is a rear perspective view of an upper portion of the first embodiment of the inventive clamp.

FIG. 2I is a cross-sectional view of the first embodiment of the inventive clamp.

FIG. 2J is a perspective view of the first embodiment of the inventive clamp attached to a truck and a utility rack.

FIG. 2K is a perspective view of variation of the first embodiment of the inventive clamp attached to a truck and a utility rack.

FIG. 3A is a front perspective view of a second embodiment of an inventive clamp.

FIG. 3B is a side view of the second embodiment of the inventive clamp.

FIG. 3C is a front view of the second embodiment of the inventive clamp.

FIG. 3D is a back view of the second embodiment of the inventive clamp.

FIG. 3E is a rear perspective view of the second embodiment of the inventive clamp.

FIG. 3F is a rear perspective view of an upper portion of the second embodiment of the inventive clamp.

FIG. 3G is a cross-sectional view of the second embodiment of the inventive clamp.

FIG. 3H is a perspective view of the second embodiment of the inventive clamp attached to a truck and a utility rack.

### DETAILED DESCRIPTION

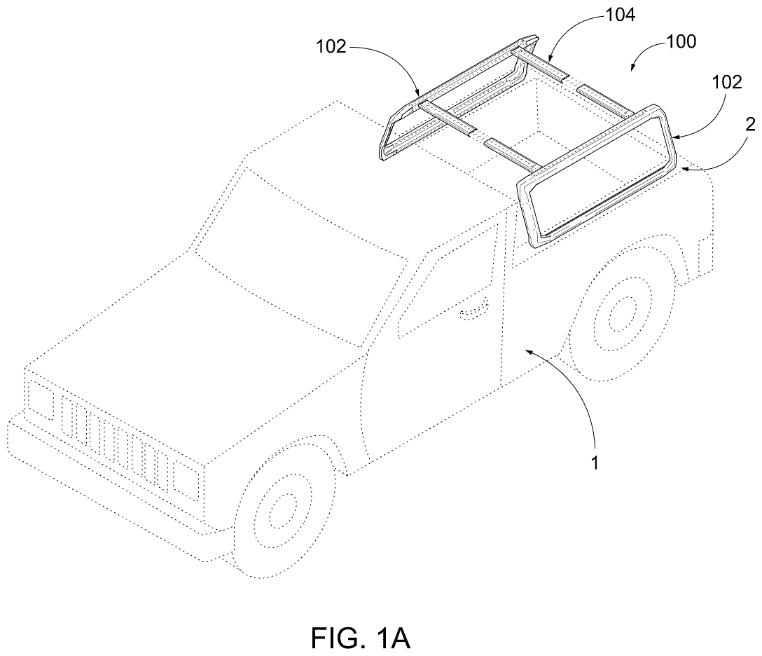

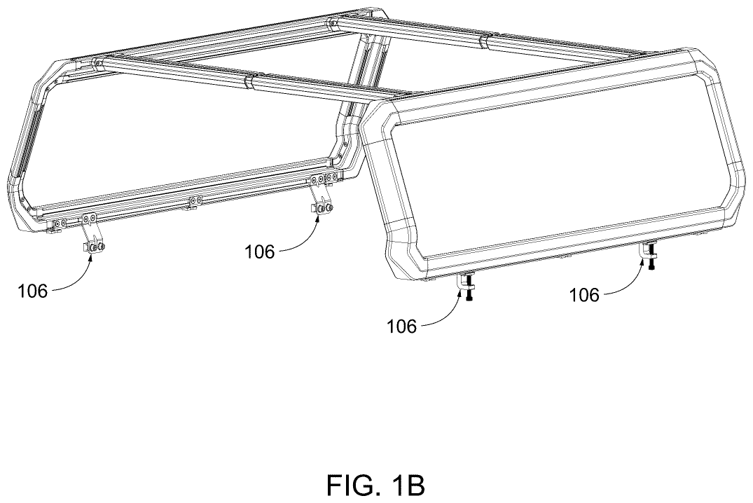

Trucks and other utility vehicles are often provided with accessory or utility racks for carrying equipment or for aesthetics. An example of such an accessory or utility rack 100 is depicted in FIG. 1A. In the depiction, the rack 100 is disposed on the top edge of the sidewalls 2 of the bed of a truck 1. Such racks 100 may be attached to the top of the side walls 2 by C-clamps or similar mechanisms. When a user removes a rack 100 from the truck 1, the clamps must typically be removed and stored apart from the truck and rack. In some cases, the clamps must be attached to the rack at varying positions to allow the user to obstructions or features of the truck bed as needed to best fit the truck. The varying location of the clamps results in a lengthy installation process after each time the rack is removed from the truck because the functional locations for the clamps must be redetermined each time the rack is reinstalled.

In the rack depicted in FIG. 1B, the clamps 106 may be slid along the entire length of the lower beam of the side frame 102. This adjustability is helpful in securing the rack on the bed of the truck but when the rack is removed from the truck the preferred clamp location may be lost thus taking additional time to redetermine when reattaching the rack to the truck. The improved clamp device disclosed herein may be disconnected from the truck without losing its indexing of one or more clamp devices to their preferred location on the truck bed.

Also, some clamps like two of those shown in FIG. 1B require tightening from the bottom, which may be inconvenient or difficult to perform due to the side wall 2 design or the placement of cargo in the bed of the truck. An improved clamp described herein has a top adjustment mechanism.

The utility rack 100 in FIGS. 1A and 1B is depicted with two side frames 102 and two crossbars 104 extending between them, though the specific design of the utility rack 100 is not limiting of the inventive clamp mechanisms described herein.

The operable location of the clamps on the bed and rack may be limited by structural members of the side wall of the truck bed or of the wheel well, or equipment stored in the truck bed. Removing the clamps entirely from the rack 100 or side wall 2 when the rack is removed from the truck results in a need to redetermine the desired position upon reinstallation of the rack 100 onto the vehicle 1. An example of possible locations of clamp mechanisms 106 on a utility rack 100 is depicted in FIG. 1B. The clamp mechanisms 106 depicted in FIG. 1B are not embodiments of the inventive clamp mechanism but indicate examples of the location and spacing used for the clamps 106 when attaching the utility rack 100 to the side walls of a truck bed.

In some embodiments the inventive rack described herein provides a two-part clamp device that separates upon removal of the rack, with one upper portion remaining attached to the utility rack. In some embodiments a lower portion remains attached to the truck bed such as on the side wall, or in other embodiments both portions may be disconnected from the rack and the truck side wall. In some embodiments the upper portion may be formed as part of the utility rack.

In some of these embodiments the inventive rack clamp device may be located at a range of positions on the rack. In some such embodiments the position may be selected to avoid obstructions to the clamp device on the truck bed. In some embodiments the range of positions is provided by including a t-channel in the rack on which the clamp device may be attached anywhere along the length of the t-channel. In some of those embodiments one portion of the clamp device remains fixed to the rack and the other portion remains fixed to the truck bed when the rack is removed from the truck. The portions of the clamp device that remain attached to the rack (whether all or only part of the clamp device) allow the rack to be quickly realigned with the desired position on the truck during reinstallation without locating the best positions for the clamps each time the rack is reattached to the truck.

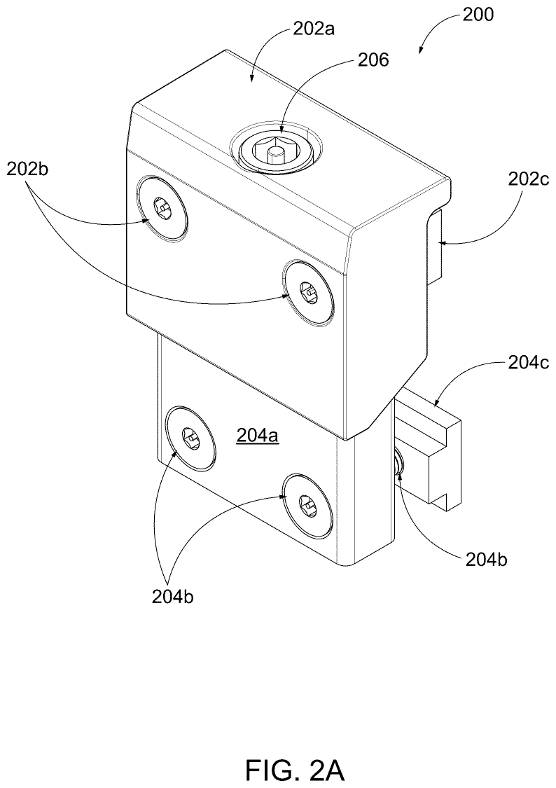

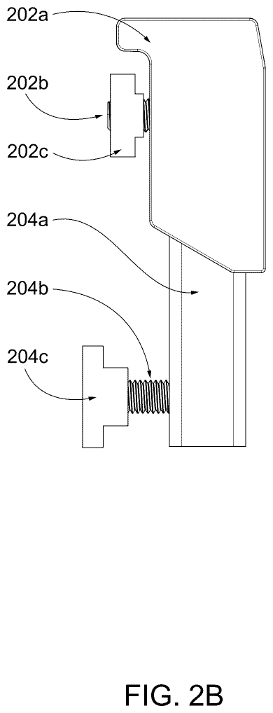

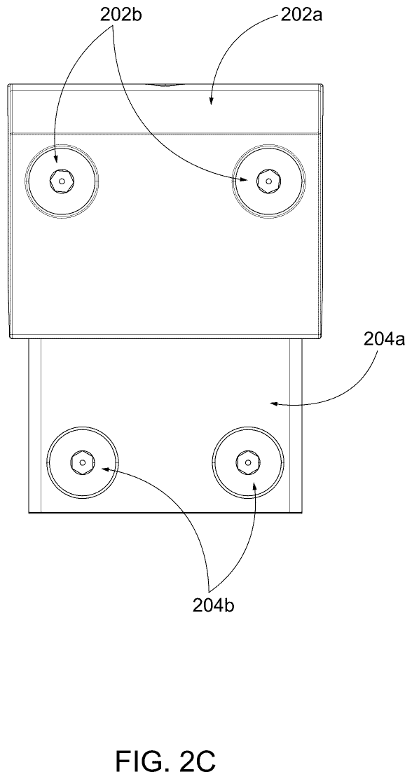

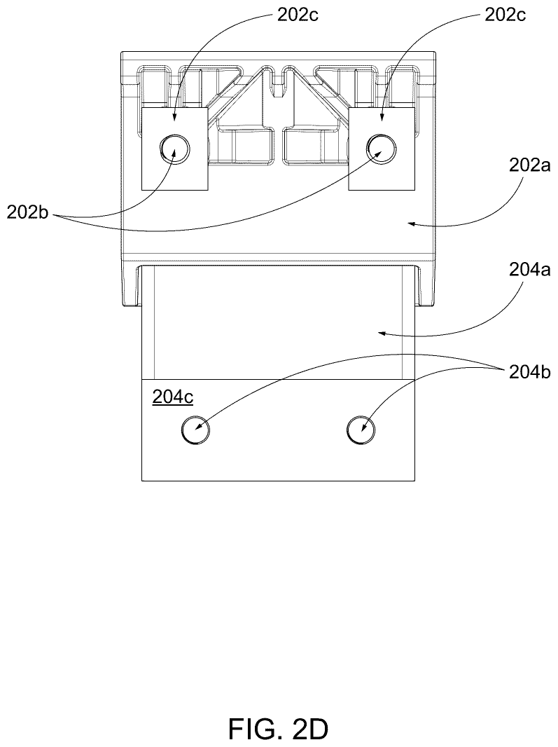

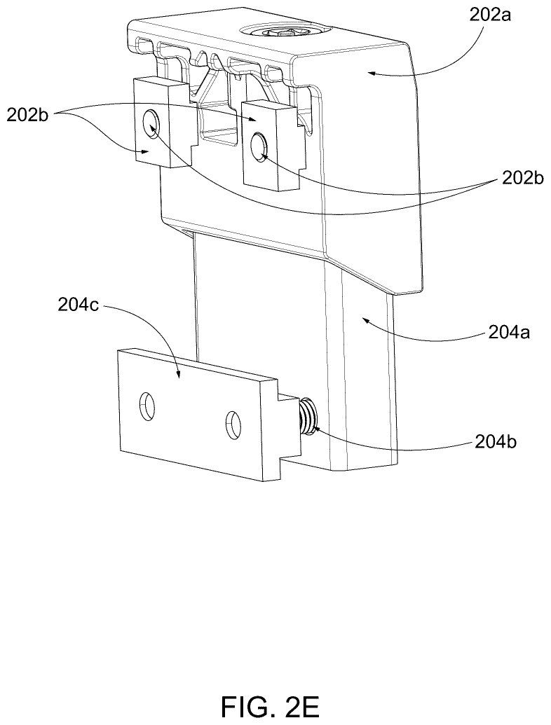

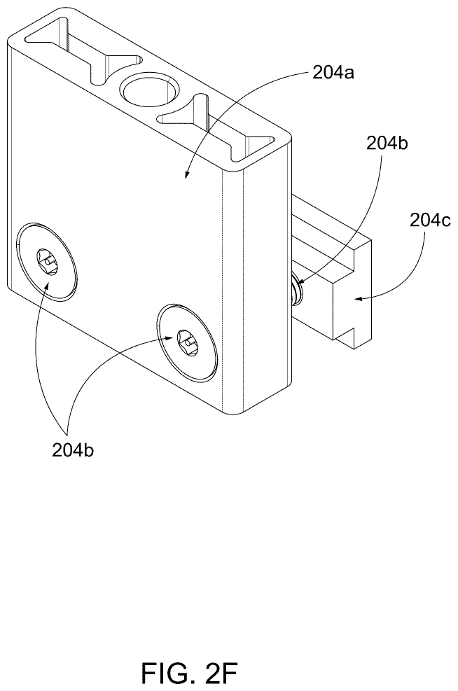

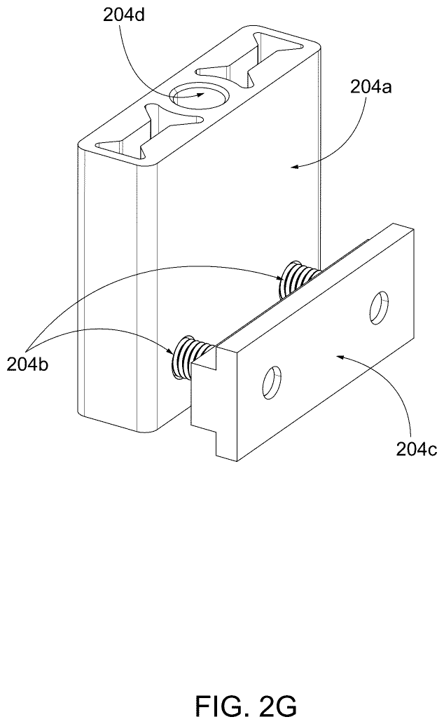

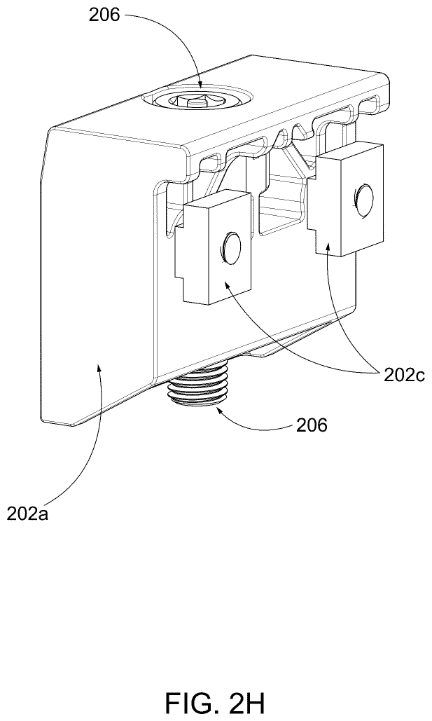

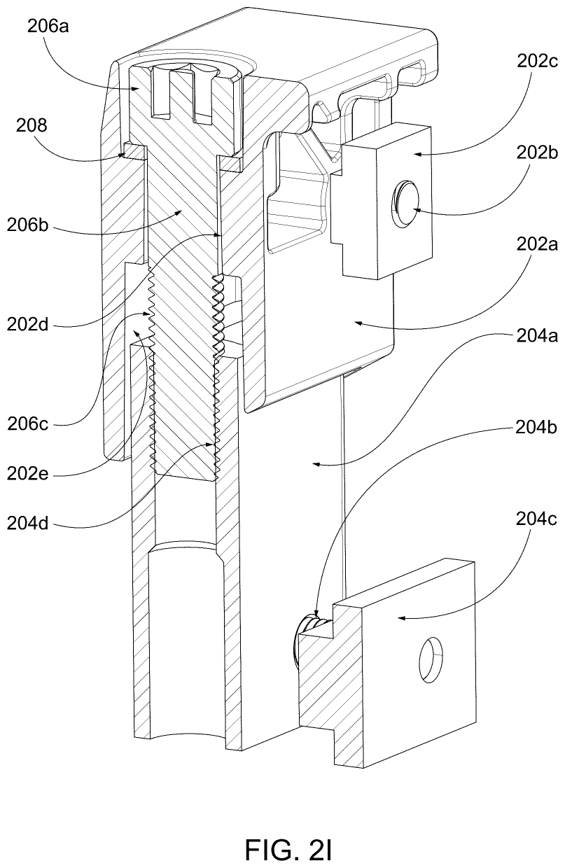

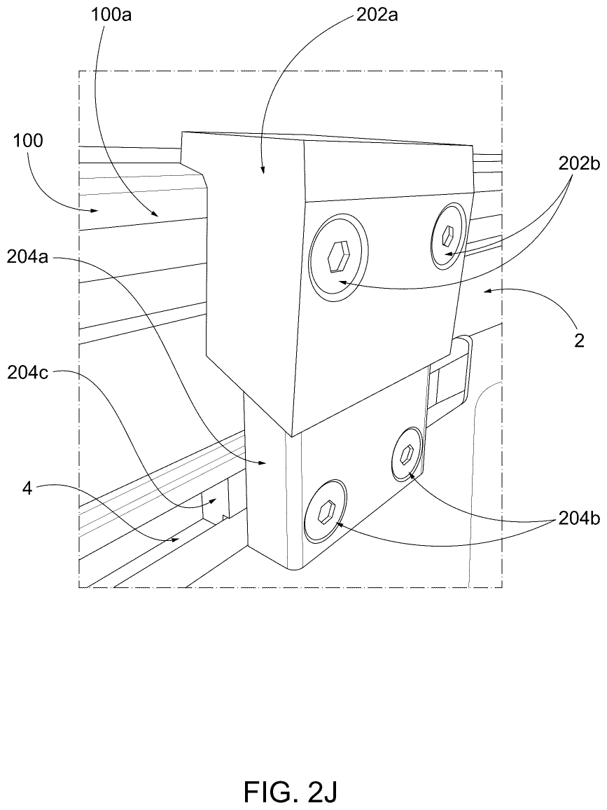

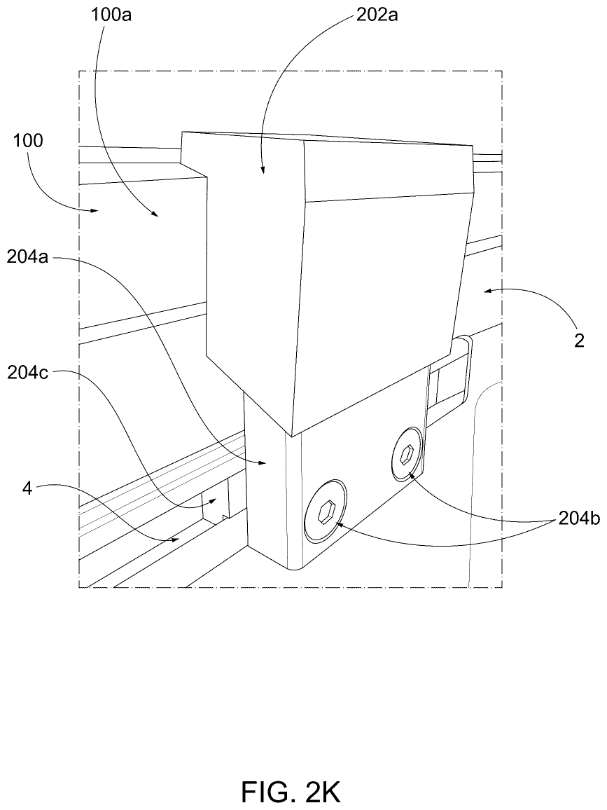

Referring to FIGS. 2A through 2J, a first embodiment of an inventive clamp 200 is depicted. The depicted embodiment comprises an upper portion 202 and a lower portion 204. The upper portion 202 is typically semi-permanently attached to a utility rack 100 or similar accessory. The lower portion 204 is typically semi-permanently attached to the truck bed side wall 2 or another portion of the truck or utility vehicle. In this case semi-permanently means that the clamp portions may be removed from the truck or rack during installation or deinstallation but are not removed therefrom during normal use of the rack on a truck.

In the depicted embodiment, the upper portion 202 is provided with two mounting bolts 202b that are disposed in apertures through the upper body 202a. The bolts 202b engage t-nuts 202c, which may be inserted into a t-channel in the utility rack 100 prior to tightening of the bolts 202b. Once the bolts 202b are tightened sufficiently the upper body 202a is held securely on the utility rack 100 and is not movable (with respect to the utility rack 100) without loosening the bolts 202b. In other embodiments, the t-nuts 202c may be replaced with another type of mechanism for securing the upper body 202a to the utility rack 100, such as standard nuts or threaded holes in the utility rack 100 for directly receiving the threaded portions of the bolts 202b.

Similarly, the lower portion 204 of the depicted embodiment comprises a body 204a that receives two mounting bolts 204b through apertures in the body. In the depicted embodiment, the bolts both engage a single, long t-nut 204c. In other embodiments each bolt 204b may be provided with a separate t-nut 204c similarly to the depicted upper portion. In some embodiments the upper portion may also be provided with a long t-nut 202c that is connected to two bolts 202b. The lower t-nut 204c may be inserted into a t-channel that is incorporated into the side wall 2 of the truck bed, or it may be inserted into a t-channel on another accessory that is attached to the truck, such as a tonneau cover or a t-channel accessory attachment system. In some trucks a t-channel is provided on the inside of the side wall, near or adjacent to the top edge thereof. In other embodiments, the t-nuts 204c may be replaced with another type of mechanism for securing the lower body 204a to the sidewalls of truck 2, such as threaded holes in the side wall 2 for directly receiving the threaded portions of the bolts 202b.

In the depicted embodiment, clamping bolt 206 is disposed in an aperture 202d through the upper body 202a to engage threads in the lower portion 204. In the depicted embodiment the threaded portion 206c of the bolt 206 engages threaded aperture 204d in lower body 204a. In other embodiments the bolt 206 may engage a nut or other threaded component attached to or on the opposing surface of lower portion 204. The clamping bolt 206 provides a tightening force to pull the upper clamp portion 202 downward onto the lower claim portion 202 to clamp the utility rack 100 onto the top of side walls 2.

In the depicted embodiment the upper end of lower portion 204 slides into a cavity 202e in the lower surface of the upper portion 202. This insertion of one portion into the other in some embodiments adds stability and improves alignment between the components and assists in aligning the rack 100 to the truck during the attachment process.

In some embodiments the bolt 206 freely rotates in the aperture 202d in upper body 202a. In some embodiments the aperture may be provided with a cavity for receiving a head 206a of bolt 206 and a shoulder for preventing it from moving completely through the aperture 202d. In some embodiments the aperture 202d is unthreaded and larger in diameter than the threads on the bolt 206. In some embodiments the shaft portion 206b of the bolt 206 disposed in the aperture 202d is not threaded. A washer or bearing 208 may be provided between the head of bolt 206 and the shoulder in the cavity in the upper portion 202.

The bolt 206 is adjustably attached to the lower portion 204 of the clamp 200 such that rotating the bolt 206 in one direction will the two portions 202 and 204 towards each other and rotating the bolt 206 in the other direction will move the two portions 202 and 204 away from each other. The fixed attachment of each portion 202 and 204 to the utility rack 100 and the truck 1, respectively, create a clamping force as they are pulled together as the upper and lower portions 202 and 204 move toward one another. In some embodiments the utility rack 100 will contact the top surface of side wall 2 (or any liner, cap, tonneau cover, or other accessory attached on top of the side wall 2) and be secured thereon by the force applied by the clamp 200.

In some embodiments the upper portion 202 may be completely disconnected from the lower portion 204 while both of them are mounted on the rack 100 and truck side wall 2. In the depicted embodiment this is performed by backing the bolt 206 completely out of aperture 204d by unscrewing it. This will cause the head of bolt 206 and part of its shank to translate up and out of the aperture 202d in upper body 202a. Once all the bolts 206 in all the clamps on a rack 100 are disconnected in this manner, the entire rack 100 may be lifted off the truck, taking the upper portions 202 with it since they are attached by t-nuts 202c. The lower portions 204 remain behind, attached to the truck 1 by t-nut 204c. Thus, for example in a configuration like that shown in FIG. 1B with 4 t-channel mounts, at least 8 bolts must be removed before the rack 100 may be removed from the truck. In the depicted embodiment of the inventive clamp, only four bolts 206 would have to be disconnected, one for each clamp, and the upper and lower portions 202 and 204 of the clamps remain attached to the rack 100 and the truck in the correct positions. Reattaching the rack 100 to the truck 2, simply entails placing rack 100 on the truck so that the lower portions 204 still attached to the truck bed side walls 2 insert into the cavities on the upper portions 202, and then tightening the four bolts to clamp the rack in place. No realignment of parts or components is necessary, and there are no parts to store separate from the rack 100 or the truck.

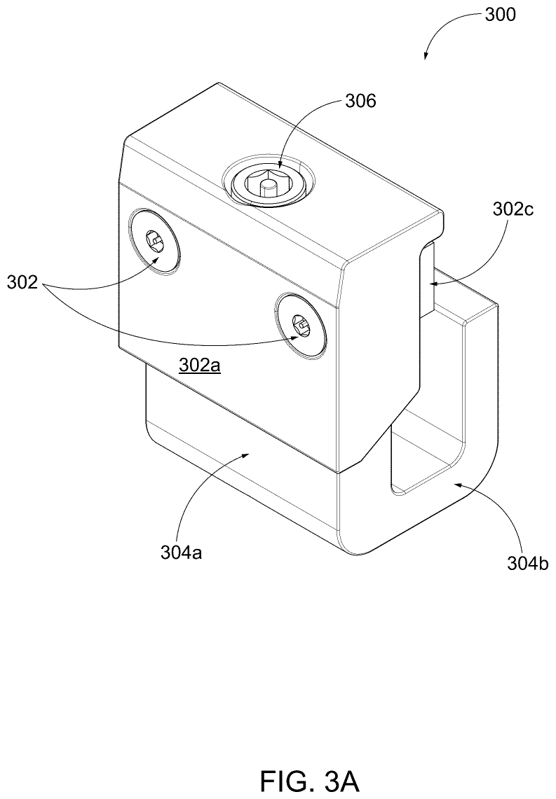

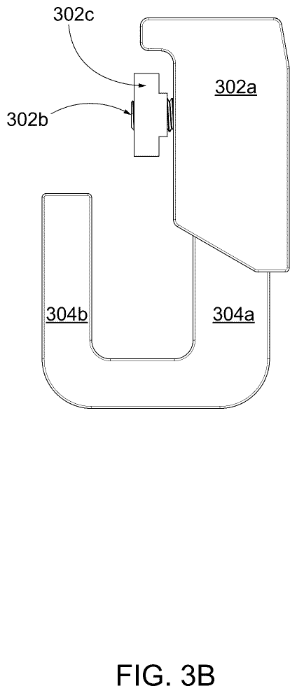

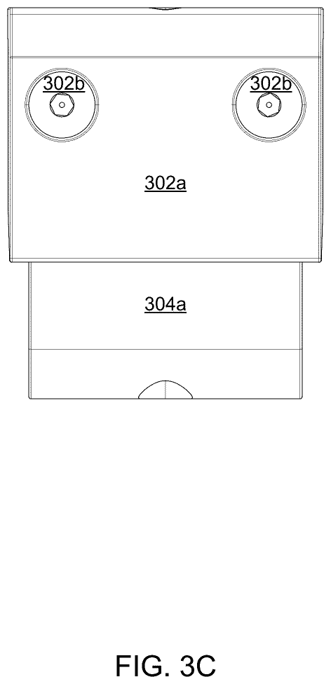

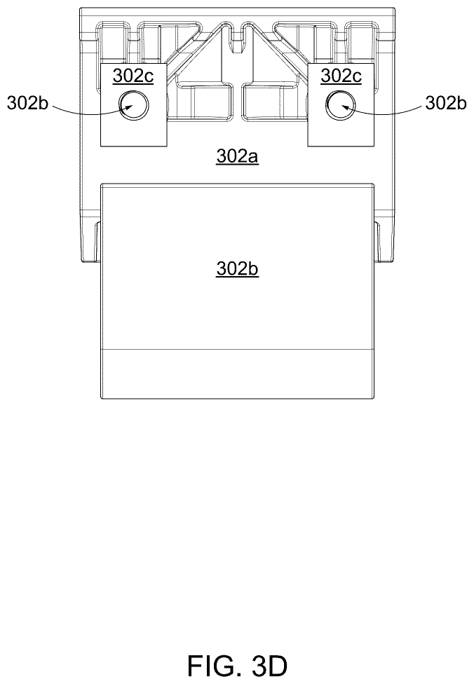

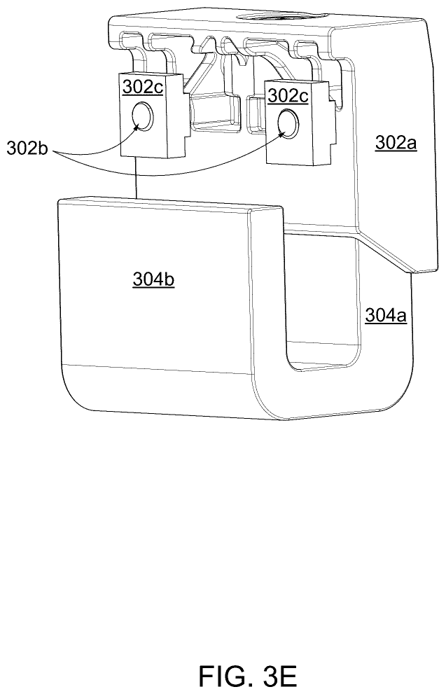

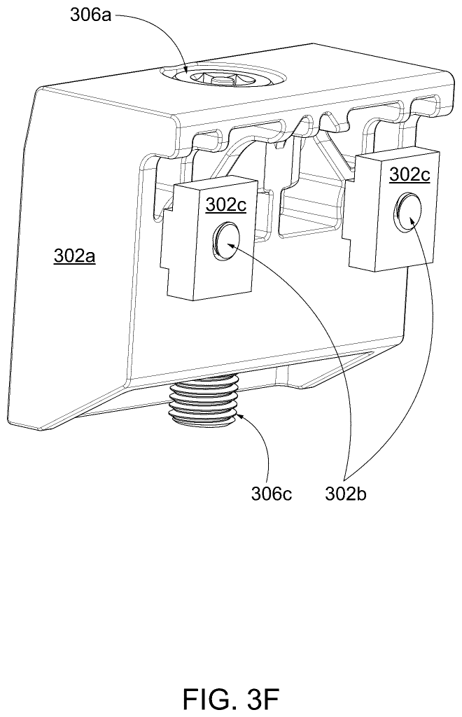

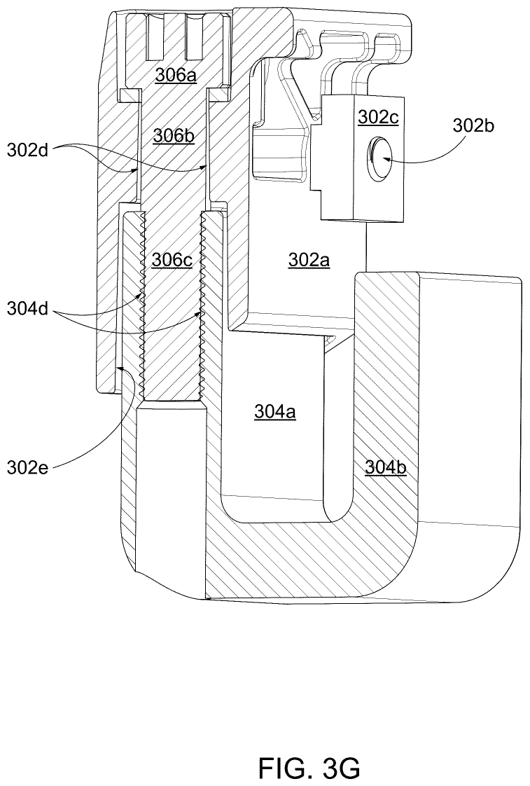

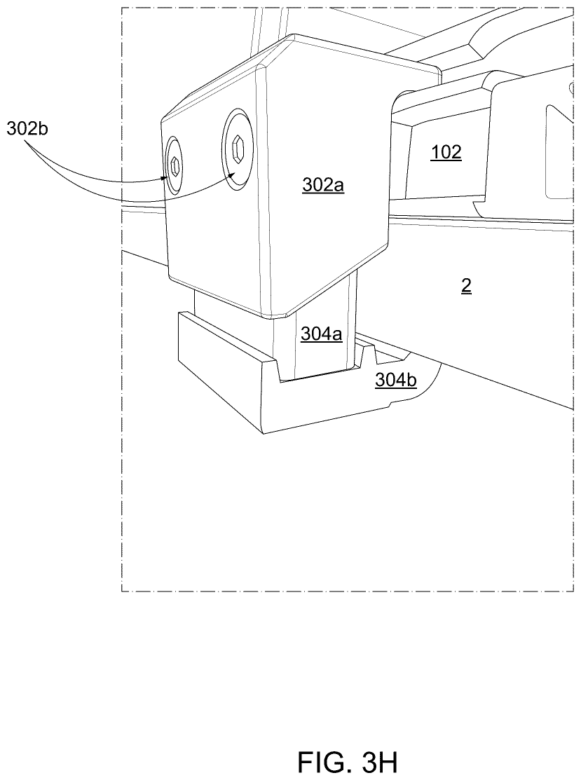

Referring to FIG. 2K, a variation of the first embodiment of the clamp is depicted. In this embodiment upper body 202 is permanently affixed to or formed as part of one of the parts of the utility rack 100. In the depicted embodiment the upper body 202 is welded or formed unitarily with a portion of the side frame 100 of the depicted rack. Specifically, the upper body 202 may be made as part of the lower rail of a side frame 102. In other embodiments, the upper body 202 could be part of the lower rail of side frame 102, such that the bolt 206 extends downwardly through some portion of the lower rail or of a bracket or elbow attached to the side frame 102 or its lower rail. In some of these embodiments the lower rail or elbow of side frame 102 may be provided with a cavity like the cavity 202e (in FIG. 2I) or 302e (in FIG. 3G) to receive a lower portion such as those shown in the depicted embodiments as lower portions 204 or 304.

Referring now to FIGS. 3A through 3G, an embodiment of an inventive clamp 300 is depicted. In this depicted embodiment, the upper portion 302 is substantially the same as the upper portion 202 of the embodiment described in relation to FIGS. 2A through 2J. The lower portion 304 is the same as lower portion 204 of the prior embodiment with respect to its attachment to the upper portion 302 via bolt 306. Like parts are numbered with only the hundreds digit changed from 2 to 3, for example the head 306a, shaft 306b, and threaded portion 306c of bolt 306 correspond to portions 206a, 206b, and 206c of bolt 206. Lower portion 304 differs from the prior embodiment in that it does not attach to the truck via bolts and nuts, but via a J-hook 304b which engages a lower surface of the side wall 2 of the truck. When utilizing this embodiment, the bolt 306 may be completely unthreaded from lower portion 304, thus separating the two portions, or it may be unthreaded sufficiently to translate the J-hook portion downward sufficiently to disengage from the side wall 2 of the truck. Then the rack 100 may be removed from the truck while the clamp 300 remains fixed in place on it for ease of reattachment.

“Substantially”, “approximately”, or “about” means to be more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. The terms “about” or “substantially” or “approximately” as used herein indicates the value of a given quantity that can vary based on a particular technology. Based on the particular technology, the term “about” or “substantially” or “approximately” can indicate a value of a given quantity that varies within, for example, 1-15% of the value (e.g., +1%, +2%, +5%, +10%, or +15% of the value).

“Comprising,” “including,” and “having” (and conjugations thereof) are used interchangeably to mean including but not necessarily limited to, and are open-ended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

Aspects of the present disclosure are described in detail with reference to aspects thereof as illustrated in the accompanying drawings. References to “one aspect,” “an aspect,” “some aspects,” “an embodiment,” “varying embodiments,” etc., indicate that the aspect(s) described may include a particular feature, structure, or characteristic, but every aspect or embodiment may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

1. A cargo rack for attachment to a bed of a truck, the cargo rack comprising:
a first side rail for attachment to a first sidewall of a bed of a truck;
a second side rail for attachment to a second sidewall of a bed of a truck, the second sidewall being laterally opposed to the first sidewall;
a first and second clamp device attached to the first side rail;
a third and fourth clamp device attached to the second side rail;
wherein each of the clamp devices comprise:
an upper clamp assembly comprising an upper clamp body, at least one mounting bolt, and at least one mounting nut, wherein the at least one mounting bolt extends through a mounting aperture in the upper body and is threaded into the at least one mounting nut;
a lower clamp assembly comprising a lower clamp body, at least one mounting bolt, at least one mounting nut, wherein the at least one mounting bolt extends through a mounting aperture in the lower body and is threaded into the at least one mounting nut; and
a clamping bolt;
wherein the clamping bolt extends through an aperture in the upper clamp body and is threaded into a threaded aperture in the lower clamp body; and
wherein the upper clamp assembly remains secured to the utility rack by the at least one mounting bolt when the clamping bolt is unthreaded from the lower clamp body; and
wherein the lower clamp assembly remains secured to the sidewall of a truck bed by the at least one mounting bolt when the clamping bolt is unthreaded from the lower clamp body.

2. The cargo rack of claim 1 wherein the at least one mounting nut of each upper clamp assembly is a t-nut that is configured to slide in a t-channel in a side rail of the cargo rack when in a disengaged configuration.

3. The cargo rack of claim 2 wherein the at least one mounting nut of each lower clamp assembly is a t-nut that is configured to slide in a t-channel in a side rail of the cargo rack when in a disengaged configuration.

4. The cargo rack of claim 3 wherein the upper body of each clamp device further comprises a cavity for receiving a portion of the lower body of the clamp device.

5. The cargo rack of claim 4 wherein the clamping bolt of each clamp device is configured to translate the lower body into the cavity when the clamping bolt is rotated in a first direction.

6. The cargo rack of claim 5 wherein the clamping bolt of each clamp device is configured to translate the lower body out of the cavity when the clamping bolt is rotated in a second direction that is opposite to the first direction.

7. The cargo rack of claim 1 wherein each clamp device is attached to a side rail at a desired position to avoid obstructions in the bed of the truck.

8. The cargo rack of claim 7 wherein the lower clamp assemblies remain attached to the desired positions on the truck bed when the upper clamp assemblies are removed from the truck with the remainder of the cargo rack.
